(19) United States
(12) Patent Application Publication
(10) Pub. No.: US 2010/0031309 A1
(43) Pub. Date: Feb. 4, 2010

(54) POLICY BASED CONTROL OF MESSAGE DELIVERY

(75) Inventors: Martin J. Gale, Eastleigh (GB); David J. Locke, Eastleigh (GB); Andrew D. Reynolds, Southampton (GB)

Correspondence Address: CANTOR COLBURN LLP - IBM RSW, 20 Church Street, 22nd Floor, Hartford, CT, 06103, US

(73) Assignee: International Business Machines Corporation, Armonk, NY (US)

(21) Appl. No.: 12/184,050

(22) Filed: Jul. 31, 2008

(51) Int. Cl. H04L 9/00

(52) U.S. Cl. 726/1

(57) ABSTRACT

A method of policy based message delivery in a message delivery system includes supplementing a subscriber handle with supplemental information pertaining to a subscriber of the message delivery system, where the message delivery system including a set of subscribers, receiving a message for delivery within the message delivery system, comparing a set of policies with the supplemental information based on information contained in the received message, matching the message to a subscriber of the set of subscribers based on the comparison, and dispatching the message to a matched subscriber based on the matching.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Technical Field

This invention generally relates to message delivery. More particularly, this invention relates to policy based control of message delivery in publish/subscribe systems.

2. Description of Background

Publish/subscribe (pub/sub) messaging generally operates on a model where interest is registered in a particular stream of data packets matching particular semantic information, for example, either in terms of a matched topic and optionally a message selector. According to conventional practice, if a client subscribes to a given topic pattern, the client will receive all messages published to topics matching their given pattern.

### SUMMARY

A method of policy based message delivery in a message delivery system includes supplementing a subscriber handle with supplemental information pertaining to a subscriber of the message delivery system, where the message delivery system including a set of subscribers, receiving a message for delivery within the message delivery system, comparing a set of policies with the supplemental information based on information contained in the received message, matching the message to a subscriber of the set of subscribers based on the comparison, and dispatching the message to a matched subscriber based on the matching.

Additional features and advantages are realized through the techniques of the exemplary embodiments described herein. Other embodiments and aspects of the invention are described in detail herein and are considered a part of the claimed invention. For a better understanding of the invention with advantages and features, refer to the detailed description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a method of policy based message delivery, according to an example embodiment; and

FIG. 2 illustrates a computer apparatus, according to an example embodiment.

The detailed description explains an exemplary embodiment, together with advantages and features, by way of example with reference to the drawings.

### DETAILED DESCRIPTION

According to an exemplary embodiment, a system and methodology are provided which significantly increase the accuracy of message delivery in publish/subscribe message systems. This increase in accuracy simplifies subscription to messaging and may provide restriction of message delivery based on recipient criteria such as, for example, communication connections, recipient location, etc.

According to an example embodiment, a policy based method to control message delivery may include supplementing subscriber handles in a messaging system with additional information relating to a client, for example, with additional meta-data. The additional meta-data may include a subscriber's Internet Protocol (IP) address or any other suitable information. Messages to be transmitted may be published into a message broker and consumed by the pub/sub system, for example, in a matching scheme. As the message is matched to a subscriber, the additional meta-data may be processed through a rule-based system (e.g., a policy system).

The rule-based system/engine may consume administrative policies concerning the client meta-data. For example, a rule of the rule-based system may dictate that if a message payload contains a particular string, the message should not be delivered to a particular set of IP addresses (e.g., an IP address containing a particular address or portion thereof). Further, if the supplemental matching through the rule-based system yields a match, the message may be dispatched to a particular subscriber or group of subscribers.

A message broker or message brokering system (including delivery systems) is generally a backbone of a computer system which converts messages/files to formats suitable for different applications of a computer system. A message broker may create artifacts to control messages, may understand formats for applications of the computer system, and may include a node to route messages. Therefore, a message broker is an intermediary program that translates a message from a formal messaging protocol of a sender to a formal messaging protocol of a receiver in a communication network where programs communicate by exchanging formally-defined messages.

Publish/subscribe (or pub/sub) is an asynchronous messaging paradigm where senders (publishers) of messages are not programmed to send their messages to specific receivers (subscribers). Rather, published messages are characterized into classes and/or categories, without knowledge of what (if any) subscribers there may be. Subscribers express interest in one or more classes, and only receive messages that are of interest, without knowledge of what (if any) publishers there are. This decoupling of publishers and subscribers can allow for greater scalability and a more dynamic network topology.

In the pub/sub model, subscribers typically receive only a sub-set of the total messages published. The process of selecting messages for reception and processing is called filtering. There are several forms of filtering including topic-based and content-based.

In a topic-based system, messages are published to “topics” or named logical channels. Subscribers in a topic-based system will receive all messages published to the topics to which they subscribe, and all subscribers to a topic will receive the same messages. The publisher is responsible for defining the classes of messages to which subscribers can subscribe.

Alternatively, in a content-based system, messages are only delivered to a subscriber if the attributes or content of those messages match constraints defined by the subscriber. The subscriber is responsible for classifying the messages. Systems may support a hybrid of topic/content filtering, for example, where publishers post messages to a topic while subscribers register content-based subscriptions to one or more topics.

According to an example embodiment, a rules-engine or policy based message delivery concept is introduced to the filter examples given above. For example, further matching of subscribers against a set of rules (e.g., policies) is established to limit message delivery based on any number of administrative policies. It follows that according to example embodiments, greater accuracy for delivered messages may be obtained according to any rules/policies included in a message delivery system. These rules may be facilitated within a methodology for message delivery.

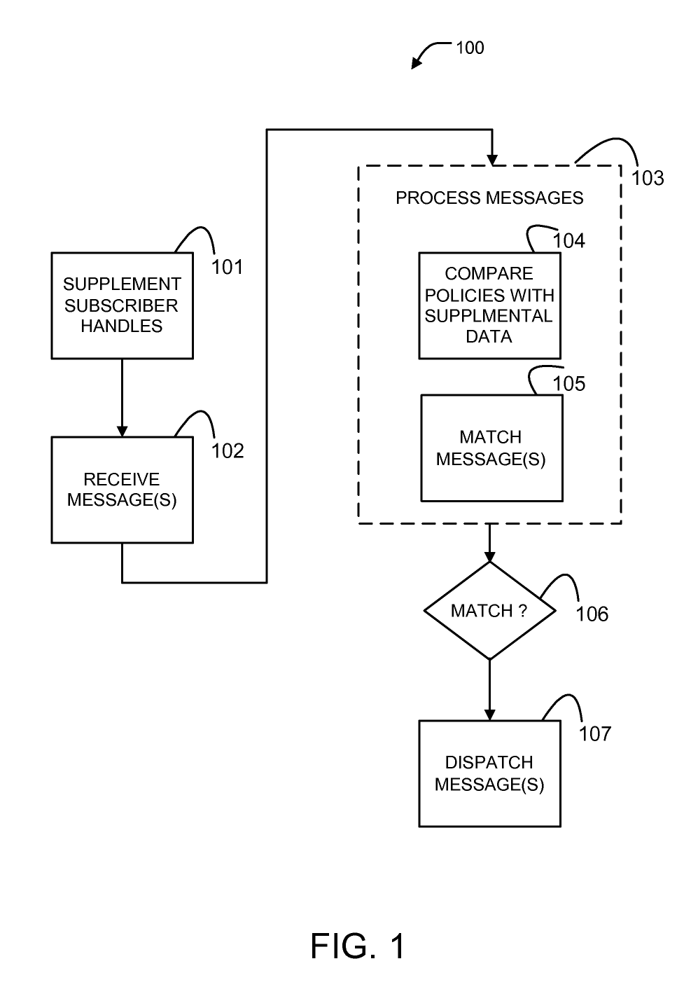

Turning to FIG. 1, a method of policy based message delivery is illustrated. According to the method 100, subscriber handles (i.e., handles to a connected socket of a client) may be supplemented at block 101. For example, a subscriber handle may include a set of information (e.g., meta-data) describing a subscriber to a message delivery system. Additional information describing the subscriber (or for example, the subscriber's connection) may be appended to the subscriber handle. The information may include, for example, a subscriber IP address, connection latencies, subscriber location, or other suitable information. Using this information, the method 100 may compare policies to subscriber handles more accurately.

The method 100 further includes receiving a message (or messages) at block 102. The messages may include any messages to be transmitted in a message delivery system. The method 100 further includes processing received message at block 103. For example, as messages are received (i.e., published) the message delivery system may consume the messages for processing. The supplemental information (described above) may be compared with a set of policies in a rules-engine (see 104). Upon comparison, the received messages may be matched to subscribers based on the comparison (see 105).

For example, the rules-engine may compare policies regarding client meta-data to the supplemental information for subscribers. The policies may concern message confidentiality or delivery options including network locations where message delivery is forbidden. In this example, the rules-engine may compare attributes of individual messages such as confidentiality, and direct delivery to only subscribers including supplemental information such as allowed IP addresses, allowed network locations, particular confidentiality or security levels, etc.

If a match is identified in method 100 (see 106), the message(s) may be routed or dispatched to the appropriate subscriber (see 107). Thus, as described above, methodologies are provided which provide increased accuracy of message delivery. For example, a rules-engine may compare a set of policies to supplemental information provided for subscribers. The comparison may facilitate message delivery to a sub-set of subscribers which match the set of policies appropriate to a received message. Accordingly, example embodiments provide message delivery methodologies where a set of policies is used for message dispatch with limited or no participation from a subscriber.

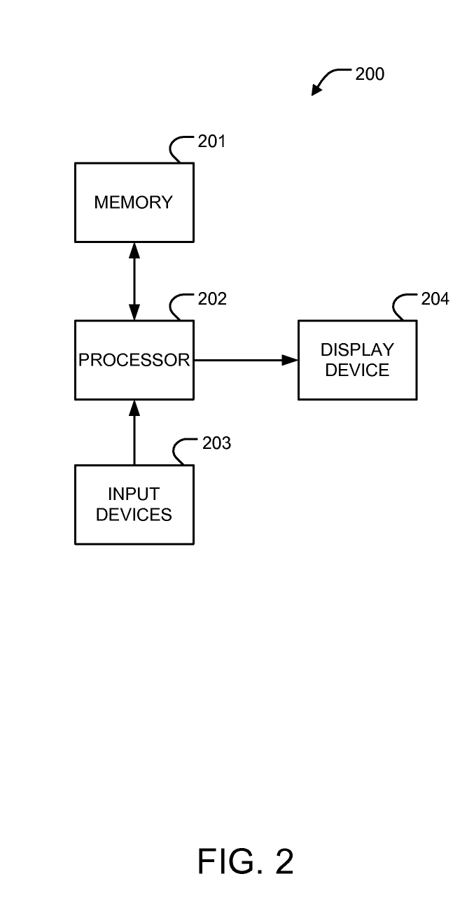

Furthermore, according to an exemplary embodiment, the methodologies described hereinbefore may be implemented by a computer system or apparatus. For example, FIG. 2 illustrates a computer apparatus, according to an exemplary embodiment. Therefore, portions or the entirety of the methodologies described herein may be executed as instructions in a processor 202 of the computer system 200. The computer system 200 includes memory 201 for storage of instructions and information, input device(s) 203 for computer communication, and display device 204. Thus, the present invention may be implemented, in software, for example, as any suitable computer program on a computer system somewhat similar to computer system 200. For example, a program in accordance with the present invention may be a computer program product causing a computer to execute the example methods described herein.

The computer program product may include a computer-readable medium having computer program logic or code portions embodied thereon for enabling a processor (e.g., 202) of a computer apparatus (e.g., 200) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read by a computer, may enable the method(s) disclosed herein, in accordance with an exemplary embodiment of the present invention.

With an exemplary embodiment of the present invention having thus been described, it will be obvious that the same may be varied in many ways. The description of the invention hereinbefore uses this example, including the best mode, to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Such variations are not to be regarded as a departure from the spirit and scope of the present invention, and all such modifications are intended to be included within the scope of the present invention as stated in the following claims.

What is claimed is:

1. A method of policy based message delivery in a message delivery system, the method comprising:
supplementing a subscriber handle with supplemental information pertaining to a subscriber of the message delivery system, the message delivery system including a set of subscribers;
receiving a message for delivery within the message delivery system;
comparing a set of policies with the supplemental information based on information contained in the received message;
matching the message to a subscriber of the set of subscribers based on the comparison; and
dispatching the message to a matched subscriber based on the matching.

2. The method of claim 1, wherein the set of policies includes:
confidentiality policies;
network location policies; or
network address policies.

3. The method of claim 1, wherein the supplemental information includes:
connection latency;
network type;
a subscriber network address;
a subscriber network location; or
a subscriber confidentiality level.

4. The method of claim 1, wherein the message delivery system is a publish/subscribe message delivery system.
